(19) United States
(12) Patent Application Publication
(10) Pub. No.: US 2011/0279683 A1
(43) Pub. Date: Nov. 17, 2011

(54) Automatic Motion Triggered Camera with Improved Triggering

(76) Inventors: Edward John Yarmchuk, Creedmoor, NC (US); Dominic Christopher Bruen, Poughkeepsie, NY (US); Christopher William Cline, Wappingers Falls, NY (US)

(21) Appl. No.: 13/103,427

(22) Filed: May 9, 2011

Related U.S. Application Data
(60) Provisional application No. 61/395,560, filed on May 17, 2010.

(51) Int. Cl. H04N 5/225

(52) U.S. Cl. 348/169; 348/E05.024

(57) ABSTRACT

An automatic motion triggered camera with improved triggering to produce images with the target animal substantially centered in the field of view. A single motion detector, a camera, and image memory are controlled by a processor that detects changes in the motion detector output and generates a trigger signal for the camera. The trigger follows a first stage of waiting until a predetermined minimum threshold of movement is detected and a second stage of waiting until a further change in the output signal indicative of an animal being substantially centered in the field of view of the camera is detected. Compensation for camera capture delay time can be included by sampling a plurality of motion detector signals, computing an estimated time at which the animal will be centered, and triggering the camera prior to that time.

### CROSS REFERENCE TO RELATED APPLICATIONS

This application claims the benefit of provisional patent application Ser. No. 61/395,560, filed 2010 May 17 by the present inventors.

### BACKGROUND

### Prior Art

The following is a tabulation of some prior art that presently appears relevant:

U.S. Patents

| Pat. No. | Kind Code | Issue Date | Applicant |
|---|---|---|---|
| 7,643,055 | B2 | 2010-01-05 | Uebbing |

U.S. Patent Application Publications

| Pub. Number | Kind Code | Pub. Date | Applicant |
|---|---|---|---|
| 20070036535 | A1 | 2007-02-15 | Chee |

A camera that is automatically triggered by animals passing in front of it is variously referred to as a game camera, trail camera or camera trap. Typically, these are self contained, battery powered devices in weatherproof enclosures, and are used by hunters, wildlife researchers, or for security. In conventional systems, a single motion detector is used to trigger the camera. Frequently, the motion detector is a pyroelectric device that senses the infrared radiation of a warm bodied creature within its field of view which is aligned with that of the camera. Generally, the motion detector response is strongest at the center of the field of view and tapers off to the sides. The response also depends on the size, speed and distance of the animal, being weaker for small animals, slow speed, or long distance from the detector. It is often desirable to capture images of smaller animals, those which are distant from the camera, or those which move slowly so the threshold for camera triggering is preferably set as low as possible. However, larger animals passing close by will cause this threshold to be exceeded while they are still located far from the center of view resulting in images that show only a portion of the animal of interest. U.S. Patent Application Publication 20070036535 describes a system employing multiple motion detectors with overlapping fields of view to overcome this disadvantage. However, the addition of a second motion detector adds cost and complexity. U.S. Pat. No. 7,643,055 to Uebbing shows how to achieve images with the target object well positioned in the frame through the use of multiple high resolution cameras covering different fields of view and selecting an appropriate high resolution camera by analyzing a plurality of image sensing regions of a low resolution camera. The extra cost and power consumption involved in this approach make it unattractive for the typical camera trap application.

### SUMMARY

In accordance with one embodiment, a single motion detector with its field of view aligned with that of a camera is connected to a processor which generates a trigger signal for the camera using a two stage process in which a first stage consists of waiting to detect motion in the usual manner using a low threshold of detection followed by a second stage of waiting for detection of a further change in the motion detector output signal indicative of an animal being substantially centered in the field of view. The triggering of the camera following the second stage results in an image with the animal substantially centered in the frame.

### BRIEF DESCRIPTION OF THE DRAWINGS

FIG. 1 shows the hardware elements of an automatic motion triggered camera.

FIG. 2 is a flow diagram illustrating one embodiment of the present invention.

FIG. 3 is a flow diagram of an embodiment of the present invention which includes compensation for camera capture delay time.

### DETAILED DESCRIPTION

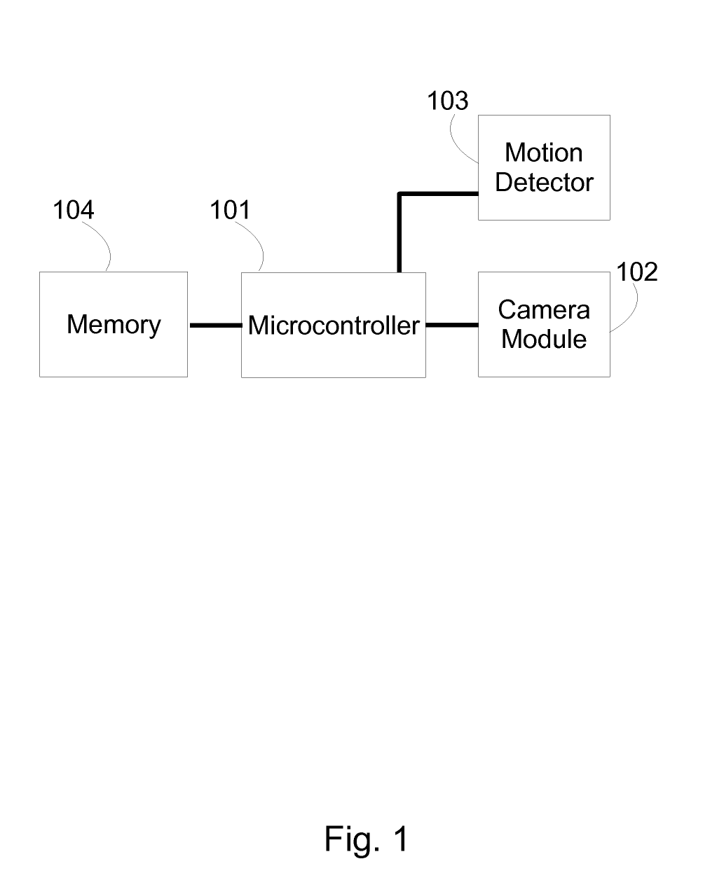

FIG. 1 shows the hardware elements of one embodiment of an automatic motion triggered camera system. Microcontroller 101 processes the output signal from motion detector 103 to provide the control signal that triggers camera 102 to capture an image of a target object as it crosses the field of view of the camera. Digital camera modules such as the MT9D111 from Aptina corporation include sophisticated digital processing capability and provide high level functionality such as automatic exposure and white balance as well as JPEG compression of images. Such modules are commercially available with integrated lens systems. Their small size, low cost, and low power consumption make them attractive for a camera trap application. These camera modules are easily interfaced to microcontroller 101 such as an Atmel ATSAM9260 which can issue a software command to the camera via standard two-wire interface causing it to capture an image and transfer the image data via standard ISI interface to memory 104. The Atmel microcontroller also has digital input and output lines suitable for interfacing to digital motion detector 103 such as the Perkin-Elmer PYD1998. This detector has a window that allows infrared radiation from a target animal to hit a pyroelectric sensing element inside the detector case. One way of aligning the motion detector with the camera field of view is to place the motion detector close to the camera module with the motion detector window facing the same direction as the camera.

### Operation

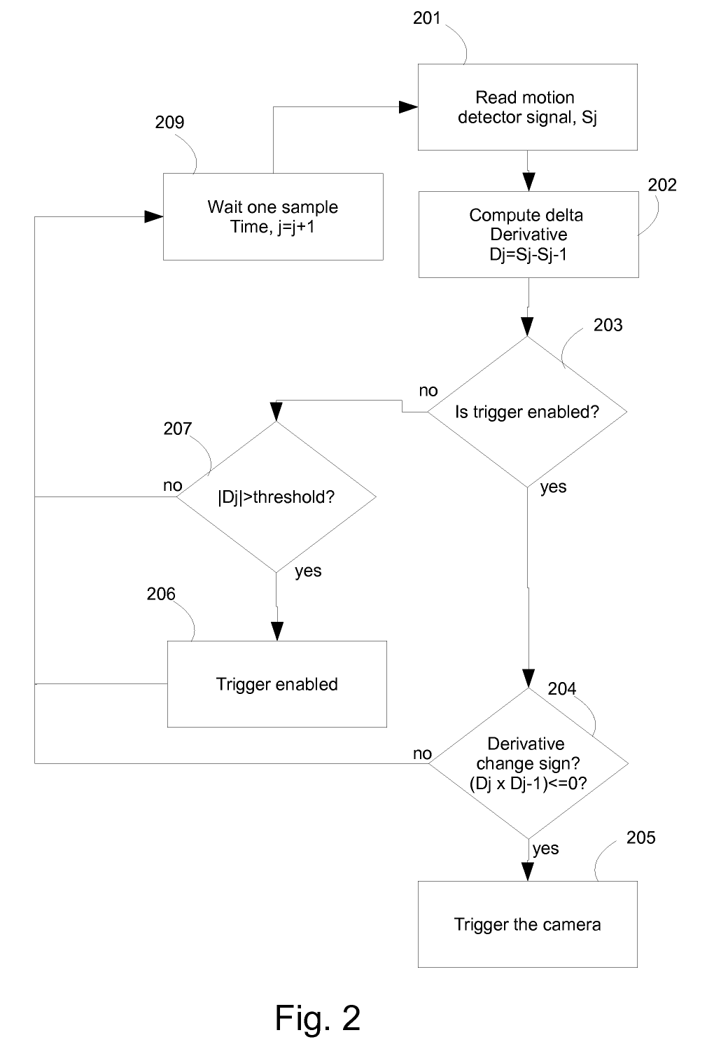

In this embodiment, microcontroller 101 samples motion detector 103 at regular intervals, applies a digital algorithm to decide when to capture an image and issues the command to camera 102 to capture an image and transfer the image to memory 104. FIG. 2 is a flow diagram that illustrates the sampling and trigger decision process in its repetitive state so that prior readings are available. It is preceded by a suitable initialization sequence in which a first motion detector reading is obtained and a logical variable representing a trigger enabled state is set to false. Starting in step 201, the motion detector signal Sj is sampled for time step j. A delta derivative Dj is computed in step 202 by subtracting the previous signal Sj-1 obtained at time step j-1. In step 203 a test is performed to determine if the trigger enabled state is true. If the result of step 203 is no, the process continues with step 207 where a test is performed to determine whether the absolute value of Dj exceeds a predetermined threshold value. If the result of step 207 is no, the loop continues with step 209 in which the system controller waits one sample time, increments the sample index, and proceeds to read the motion detector again in step 201. In the absence of movement, the system will continue looping through steps 201, 202, 203, 207, and 209 in a first stage of waiting. The first stage of waiting ends when an animal enters the field of view causing the magnitude of the derivative signal to exceed the predetermined threshold in step 207. With the result of step 207 being yes, the trigger enabled state will be set to true in step 206 and the system enters the second stage of waiting. In this stage, the looping proceeds with steps 209, 201, 202, 203 and 204 where a determination is made as to whether the derivative has changed sign. For simplicity, a value of zero is considered a change of sign. One way to calculate this is to multiply the current derivative value, Dj, by the previous value Dj-1, and test whether the product is less than or equal to zero. If so, the camera is triggered in step 205. If not, the looping continues with steps 209, 201, 202, 203, and 204 in a second stage of waiting until such time as the derivative does change sign. The result is that the triggering of the camera occurs in two stages, a first stage of waiting until a predetermined minimum threshold of movement is detected followed by a second stage of waiting until a further change in the output signal indicative of an animal being substantially centered in the field of view of the camera is detected, which in this embodiment corresponds to a change in sign of the derivative signal. Following triggering of the camera and transfer of the image data, initialization to obtain a motion detector reading and resetting the logical variable representing the trigger enabled state to false, the process would return to step 201 to await another image capture event.

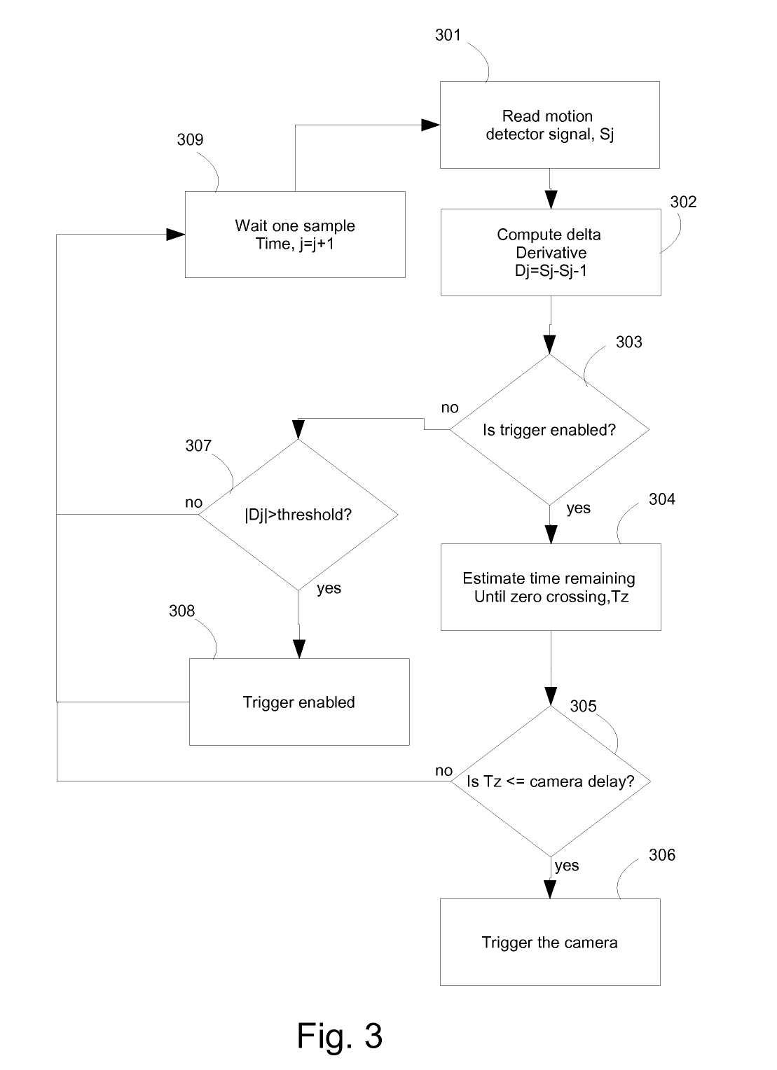

In a further refinement, a more sophisticated algorithm provides more accurate centering by using a plurality of derivative signal values to estimate the time at which a change in sign of the derivative of the detector signal is anticipated to occur and generating the camera triggering control signal prior to this estimated time by an amount of time approximately equal to the camera capture delay. This delay is the amount of time between the receipt of a triggering command and the actual capture of an image. It may be listed in the specifications for a particular camera module or can be measured using a dual trace oscilloscope to view a logical output signal generated by the microcontroller at the moment of camera triggering along with a relevant logical signal such as frame valid which is an ISI standard image transfer data interface signal produced by the camera module that will indicate when the image capture begins and ends. This delay may range from a few tenths of a second to a second or more depending on the type of camera module. One embodiment is illustrated in the flow diagram of FIG. 3. As before, this illustrates the sampling and trigger decision process in its repetitive state so that prior readings are available. It follows a suitable initialization sequence in which a plurality of motion detector readings have been obtained and a logical variable representing a trigger enabled state is set to false. Starting in step 301, the motion detector signal Sj is sampled for time step j. Delta derivative Dj is computed in step 302 by subtracting the previous signal Sj-1 obtained at time step j-1. In step 303 a test is performed to determine if the trigger enabled state is true. If the result of step 303 is no, the process continues with step 307 where a test is performed to determine whether the absolute value of Dj exceeds a predetermined threshold value. If the result of step 307 is no, the loop continues with step 309 in which the system controller waits one sample time, increments the sample index, and proceeds to read the motion detector again in step 301. In the absence of movement within the field of the motion detector, the system will continue looping through steps 301, 302, 303, 307, and 309 indefinitely. As before, the system remains in this first stage of waiting to detect motion until an animal enters the field of view causing the magnitude of the derivative signal to exceed the predetermined threshold in step 307. With the result of step 307 being yes, the trigger enabled state will be set to true in step 306 and the system enters the second stage of waiting. In this stage, the looping proceeds with steps 309, 301, 302, 303 and 304 where an estimate of the time at which the derivative signal will cross through zero and change sign is computed. There are many possible ways to compute this estimate. One way is to linearly extrapolate the waveform of the derivative signal versus time to determine it's expected zero crossing time. The simplest linear extrapolation involves only two samples. In this case, the time remaining before zero crossing Tz equals the sample interval times the present derivative divided by the difference between the previous derivative and the present derivative. In step 305 a test is applied and when the estimate Tz becomes less than or equal to the camera capture delay time, the camera is triggered in step 306. Depending on details of signal to noise ratio, sample rate, and the signal waveforms for the motion sensor, more sophisticated signal processing algorithms might be used to advantage in determining the precise time at which to issue the camera trigger command.

### Alternative Embodiments

Pyroelectric motion detectors operate by detecting the infrared emission of objects using sensing elements which convert the absorbed infrared light into electrical signals. The output from pyroelectric sensors typically drifts slowly over time due to ambient temperature variations and other factors so a high pass filter is sometimes included in the electronics. A high pass filter results in an output that is approximately the time derivative of the input. This prevents slow drift from causing false triggering. In the embodiments described above, the PYD1998 detector provides a digitized result which does not include high pass filtering so this function is included explicitly by computing the derivative of sampled digital data. Other embodiments in which high pass filtering is included in circuitry associated with the detector or in which drift of the sensor is insignificant would not require the step of computing the derivative. In conventional automatic motion triggered cameras, the camera is triggered after waiting for the motion detector signal to indicate a minimum threshold of movement. With a pyroelectric detector this indication would typically occur when the magnitude of the high pass filtered detector output exceeds a predetermined value. In the embodiments described above, the indication occurs when the magnitude of the time derivative of the PYD1998 detector output exceeds a predetermined value. As described earlier, the animal is often located near the edge of the camera field of view when this indication of movement is detected so the addition of a second stage of waiting for better positioning of the animal before triggering the camera provides an important benefit.

Often, the motion detector includes a Fresnel lens to focus the infrared emission from a central area of the field of view thereby extending the range of sensitivity to greater distances. While a Fresnel lens enhances the central sensitivity of a motion detector, off center response remains significant and initial detection will still occur for animals at the edge of the field of view when using low thresholds. Thus the present invention provides significant advantages even for detectors that include a Fresnel lens.

The waveform of detector signal versus time as an animal crosses in front of a pyroelectric motion detector depends on multiple factors including the animal size and speed, details of the background scene, ambient temperature, and the response time of the pyroelectric element. Examination of waveforms recorded under controlled conditions that are similar to those expected during operation, such as by walking past the detector at various speeds and distances, reveals features of the waveform that are indicative of the animal being approximately centered. An algorithm for detecting such an indicative feature is suitable for the second stage of waiting in this invention. A particular indicative feature found to be effective with the PYD1998 detector is a zero crossing of the time derivative waveform of the PYD1998 sensor output and the algorithm for detection consists of testing for a change in sign in the time derivative. Examination of PYD1998 waveforms recorded under controlled conditions shows that in many cases, this change in sign coincides directly with the animal being centered while in others, particularly for very slow moving animals, the derivative changes sign with the animal only slightly off center. In either case, the result of the second stage of waiting for the indicative feature consisting of a change in sign of the time derivative of the output results in substantially improved centering of the animal in the final image as compared to triggering the camera immediately following the detection of a minimum threshold of movement as in a conventional automatic motion triggered camera. For other types of motion detector, capture and examination of waveforms as described above can reveal a suitable indicative feature which might be a peak, valley, zero crossing or some other distinctive aspect.

At first glance, a change in sign of the time derivative of the output appears to be unacceptable for use as a triggering criterion because small fluctuations in sensor output cause the time derivative of the output to change sign even when no animal is present. It is certainly not useful as a triggering criterion in conventional methods of triggering using a single stage of waiting. However, in the embodiments described above, the first stage of waiting for the motion detector signal to indicate a minimum threshold of movement prevents false triggering from sensor fluctuations and ensures that a relatively strong animal movement signal is present during the second stage of waiting. Errors introduced by sensor fluctuations are therefore small and the sign change of the derivative remains a useful indicative feature for an animal being nearly centered.

### CONCLUSION, RAMIFICATIONS, AND SCOPE

According to the aspects of embodiments described here, a method for automatic capture of images of moving targets results in the target animal being substantially centered in the frame. The method can include compensation for a camera capture delay time which improves centering, especially when the camera delay is long.

A significant advantage is that only a single motion detector is needed. Another feature is that centering is provided over a wide range of target animal sizes and speeds. This method provides well centered animal images even with high sensitivity motion detection which would result in animals being outside or at the edge of the image using conventional single stage triggering.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention as described in the appended claims.

What is claimed is:

1. A method of automatic image capture of a moving target object comprising:
a. providing a camera which can be triggered to capture an image using a control signal,
b. providing a single motion detector aligned with a field of view of said camera, said motion detector producing an output signal arising from motion of said target object,
c. providing a controller means for generating said control signal from said output signal following a two stage process comprising a first stage of waiting until said output signal indicates a predetermined minimum threshold of movement followed by a second stage of waiting until a further change in said output signal indicative of an animal being substantially centered in said field of view of said camera is detected,
whereby said camera captures an image with said moving target substantially centered in said field of view.

2. The method of claim 1 wherein said output signal represents the rate of change of an output of an infrared sensor.

3. The method of claim 2 wherein said further change in said output signal indicative of an animal being substantially centered in said field of view of said camera comprises a change in sign of said output signal.

4. The method of claim 1 wherein said second stage of waiting includes:
a. recording a plurality of sampled values of said output signal at a plurality of sampling times,
b. computing an estimated future time at which said output signal will be indicative of an animal being substantially centered in said field of view of said camera,
c. completing the waiting prior to said estimated future time by a predetermined amount of time.

5. The method of claim 4 in which said computing estimated future time comprises linearly extrapolating a time waveform of said sampled values versus said sampling times to determine an estimated zero crossing time of said waveform.
